(19) United States
(12) Patent Application Publication
(10) Pub. No.: US 2008/0251132 A1
(43) Pub. Date: Oct. 16, 2008

(54) FLEXIBLE INFLATABLE PURGE BLOCK FOR HIGH PURITY WELDS

(76) Inventors: Michael Eric Bentley, Vacaville, CA (US); Debra Lyn Bentley, Vacaville, CA (US)

Correspondence Address: Michael E. Bentley, Ste.#7-187, 1989 Peabody Road, Vacaville, CA, 95687, US

(21) Appl. No.: 11/733,691

(22) Filed: Apr. 10, 2007

(51) Int. Cl. F16K 15/20

(52) U.S. Cl. 137/223

(57) ABSTRACT

A purge block comprised of latex and, mandrel dip molded in a continuous piece, with a housing bulb on one end of an elongated hollow tube capable of withstanding minimal inflation to fill the chamber in varying tube diameters, sealed at the end of the tube with a “Schrader” valve insertion, sealed with heat shrink tape, and capped with a hard rubber cap to prevent damage to metal tube. The valve and elongated tube or carriage serves as the conduit to inflate the bulbous end with argon or another inert gas. Upon inflation, the block serves to isolate small, purgable tube areas for tie in work and final welds, frequently at valves, and valves adjacent to curved tubing.

### BACKGROUND OF THE INVENTION

1. Field of Invention

This invention relates to welding equipment, and more particularly to purge blocks for use in establishing a localized inert atmosphere inside two abutting pipe or tubing sections in the region of a desired weld joint, and more specifically to purge blocks used in high purity welding.

2. Background of the Invention

It is conventional in welding to establish an inert atmosphere inside two abutting pipe or tubing sections in the region of a desired weld joint. It is also conventional to establish an inert atmosphere on the outside of the pipe sections in the region of the desired weld joint. Without an inert atmosphere, the interior surface of the welded joint is subject to oxidation, other impurities and incomplete fusion of the pipe edges, particularly in the case of stainless steel pipe. Purity is especially important to purge blocks used in high purity TIG and Orbital stainless steel welding to establish a localized, inert atmosphere inside the chamber at tie in points adjacent to valves with straight or curved tube. Such a localized atmosphere is desired to reduce oxidation of the interior surface of the welded joint, as well as deposits of impurities inherent in the metal. In high purity stainless steel welding, such oxidation can cause rejected welds during mandatory weld inspections.

In emergency field situations involving high purity environments it is often necessary to create and maintain a localized inert atmosphere to enable emergency repairs or produce final welds. Emergency repairs in high purity environments may require the blockage of moisture and require pipe or tubing lines to be sufficiently dried. Typically, an entire line is purged with a protective gas, such as argon. This process is time consuming, and in emergency repair situations, impractical. In addition, this process uses great quantities of inert gas, and can expensive.

A common practice in the field involves filling an entire pipe line with a protective gas, such as argon, and, at times, providing a continuous flow of argon gas throughout the welding operation. A known alternative to the above technique involves the use of purge block, dams or plugs, which, in one way or another, establish a localized inert atmosphere at the interior surface of a desired weld joint. It is common practice in the field to use an inflatable party balloon to create the block. Furthermore, numerous such devices have been developed exemplified by the following U.S. Patents:

| U.S. Pat. No. | Inventor | Issue Date |
|---|---|---|
| 5,187,343 | Belleride et.al. | Jun. 5, 1990 |
| 2,802,092 | Hauck | Aug. 6, 1957 |
| 2,819,517 | Pursell | Jan. 14, 1957 |
| 3,292,254 | Sloan | Dec. 20, 1966 |
| 4,931,612 | Belleride et al. | Jun. 5, 1990 |
| 5,187,343 | Edwards | Feb. 16, 1993 |

Perhaps the most basic technique for localizing the inert atmosphere is to plug both exposed ends of the pipes or tubes to be welded, for example, as show in the patent to Jessen. Similarly, some devices consist essentially of separate dams, baffles or other seals which are either removable (Hacuk, Sloan, De Facci et al. and Belleride et al, combustible (Pursell) or water soluble (Spiegel et al.).

A number of purge blocks for use in creating a closed chamber for welding under a protective gas exist, some employing the use of rigid disks, inflatable baffles, bags or similar structures. These devices are often too large to accommodate the tubing found in high purity applications, are unwieldy for the worker in the field, require a good deal of set up time, and are costly because sets of varying sizes must be purchased to work with pipe of differing diameters. These devices are constructed of multiple parts, often rigid, which are difficult to use in curved pipe structures. Devices such as these are not practical in high purity emergency environments.

U.S. Pat. No. 4,931,612 Belleride et al. describes a device with a circular support element as a disk, glued in several locations, and vulcanized, and requiring a set of five different sizes of inflatable tube. The invention is comprised of two inflatable tubes and disks joined with a circular support element for use in welding two pieces of different diameter metal pipe work. To weld bent pipe work, a cable for deflating the inflatable tube is necessary to withdraw the device through the bent zone. Such a device does not allow for the need to isolate tie in welds in valves and bent tubing. The device is not flexible, making navigation through valves and fittings difficult. In emergency situations in particular, the need to draw the device through a bent zone is cumbersome and impractical, as is the need or multiple sizes to accommodate tubing in the field.

The invention seeks to provide a low cost, reusable, fully flexible device for use in emergency or tie in and final weld situations. The device inflates quickly with inert gas via a Schrader relief valve, and deflates quickly. It can accommodate a wide range of tube sizes, from at least ½″ to 4″ ranges of Stainless Steel tubing. Because of its flexible material and design, it is easily stored in the field in the field workers tools. It does not contain disks or glues, and may be disinfected with Isopropyl Alcohol for use in high purity environments. Critical to emergency repairs in which lines must be welded with out usual preparation, the block will keep moisture from entering the chamber during the welding process.

### OBJECTS AND ADVANTAGES

Accordingly, besides the object and advantages of the purge blocks described above, several objects and advantages of the present invention are:

(a) to provide a fully flexible, easily stored inflatable block for use in establishing and isolating a small, localized inert atmosphere or inner diameter purge within abutting tube sections and valves;

(b) to provide a purge block with a valve that would vent the inert purge through a purge vent cap, clamped to the valve itself;

(c) to provide a wide range of block sizes capable of withstanding minimal pressure differences within the chamber;

(d) to provide flexibility and ease of insertion;

(e) to provide flexibility and ease of inflation; and

(f) to provide a purge block that can be used quickly and efficiently in emergency situations in the field.

Further objects and advantages are to provide a purge block that can withstand high temperatures reached during welds and that is simple to use and inexpensive to manufacture. Still further objects and advantages will become apparent from a consideration of the ensuing description and drawings.

### SUMMARY

In accordance with the present invention a purge block having a housing 2 with a housing bulb on one end of an elongated hollow tube or carriage 4, sealed at the end of carriage 4 by valve and cap 6. Valve 10 is preferably a “Schrader” valve insertion, sealed with 12 heat shrink tape, and capped with cap 8 preferably a hard rubber cap to prevent damage to metal pipe and tubing.

### DRAWINGS—FIGURES

FIG. 1 shows a purge block in elevation.

FIG. 2 shows a purge block in one possible flexible position.

FIG. 3 shows the purge block in broken view of the manual air relief valve assembly.

FIG. 4 shows the purge block manual air relief valve upon re-assembly of FIG. 3.

### DRAWINGS—REFERENCE NUMERALS

2 Housing

4 Carriage

6 Valve and cap housing

8 Cap

10 Valve

12 Shrink heat tape

### DETAILED DESCRIPTION—PREFERRED EMBODIMENT

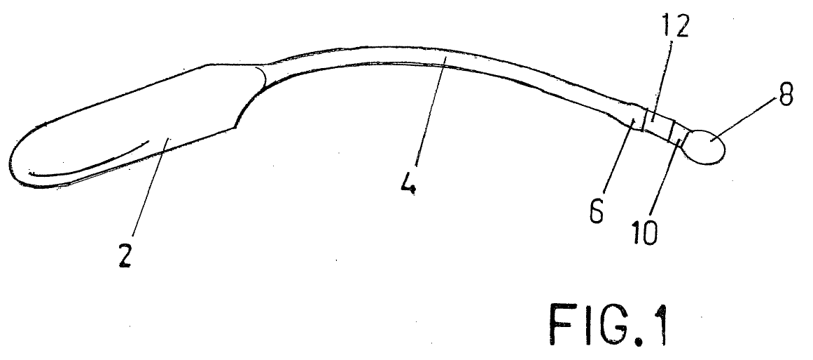

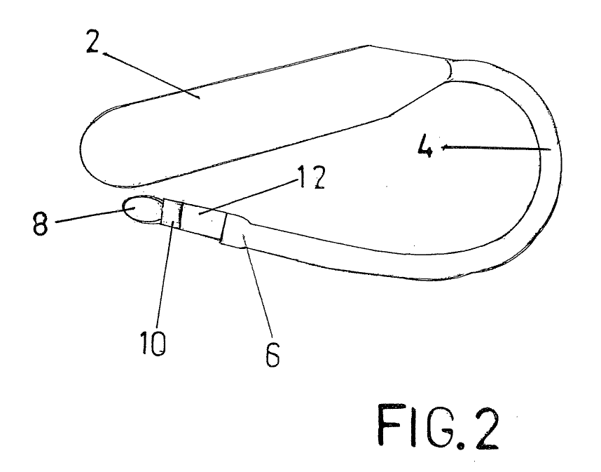

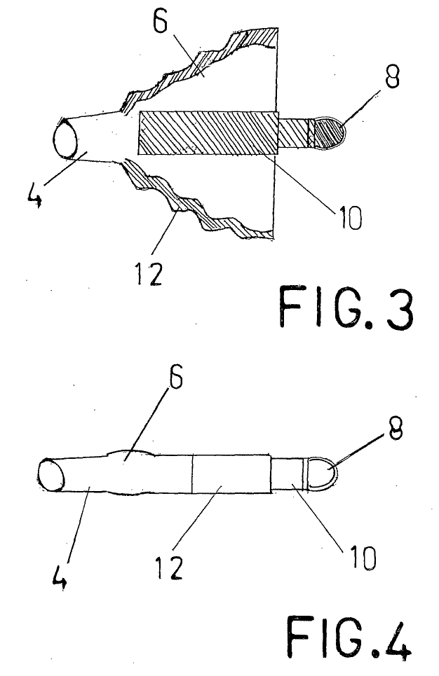

A preferred embodiment of the purge block of the present invention is illustrated in FIG. 1.

Valve 10 may be a manual air relief valve; known as a “Schrader” valve, is inserted into the culmination of carriage 4, and is wrapped in heat shrink tape. Heat is applied to shrink tape 12 and may form the seal around the insertion area. Valve 10 may be covered with cap 8. Cap 8 is preferably of rubber to prevent any chance of scratching stainless steel tubing.

Housing 2 may be capable of withstanding minimal pressure within the chamber, and inflation to psi adequate to fill the chamber in varying tube diameters. During use in a tie weld, the block is inserted through the valve, and into the abutting tube. The block is then inflated to fill the chamber, and the small elongated housing 2 and carriage 4 are manually curled toward the block itself.

The purge block has a fully flexible continuous housing 2 which may be of a mandrel, dip molded, and continuous. One end of housing 2 may be bulb like, becoming progressively narrower as carriage 4 until it culminates in a small hollow opening at one end of carriage 4. Housing 2 is typically 0.055 inches in thickness, and is roughly oblong shape. Housing 2 may be molded latex mandrel dipped to achieve flexibility. Housing 2 made from latex may be capable of withstanding some heat; however, welders in the field should not attempt removal of device until welds are cool to the touch to avoid risk of latex material melting along the weld.

From the description above, a number of advantages of the above purge block become evident. Although the description above contains much specificity, these should not be construed as limiting the scope of the invention but as merely providing illustrations of some of the presently preferred embodiments of this invention. For example, housing 2 can have other shapes, such as circular, oval, trapezoidal, etc.; cap 8 can have other shapes; valve 10 could be of plastic or metal; further, there are other means of opening and inflating the housing 2 besides a valve and cap 6.

We claim:

1. A purge block comprised of a continuous body piece, with a housing bulb at one end of an elongated hollow tube, sealed at the end of the tube with a “Schrader” valve insertion, sealed with heat shrink tape and capped.

2. Purge block body of claim 1 is characterized in that the material is latex.

3. Purge block of claim 1 is characterized in that it is sealed at the end with a “Schrader” type valve insertion allowing manual inflation with inert gas or alternative inflation means to create a closed chamber, and capped with rubber type material.

4. Purge block of claim 3 is characterized in that the valve assembly is further secured after insertion by means of heat shrink type tape.

5. A purge block capable of inflation with argon or another inert gas to establish an inert atmosphere inside two abutting pipe or tubing sections in welding across a protective gas.

6. Purge block of claim 5 is characterized in that it is capable of withstanding minimal inflation to varying chamber diameters.

7. Purge block of claim 5 is characterized in that it is fully flexible for insertion and inflation into chambers at tie in points adjacent to valves with straight or curved tubing.
